(19) United States
(12) Patent Application Publication
(10) Pub. No.: US 2004/0196965 A1
(43) Pub. Date: Oct. 7, 2004

(54) Method and apparatus for using web services to provide telephony communications

(76) Inventors: Efim Z. Birger, Sharon, MA (US); Oleg G. Pouzyrev, Norwood, MA (US); Lev B. Levitin, Brookline, MA (US); Marina Borisova, Norwood, MA (US); Edward Fredkin, Brookline, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 10/627,957

(22) Filed: Jul. 25, 2003

Related U.S. Application Data
(60) Provisional application No. 60/398,884, filed on Jul. 26, 2002.

(51) Int. Cl. H04M 11/00; H04M 1/64

(52) U.S. Cl. 379/88.13; 379/88.17

(57) ABSTRACT

A system for providing telephony control over the Internet. The control over connections, voice and other services is directed from a client computer to a server computer over the Internet. The server computer controls a switch or a device with a similar functionality. The client may dynamically generate telephony scripts and upload them onto the server for execution.

### RELATED APPLICATION

This application claims the benefit of U.S. Provisional Application No. 60/398,884, filed Jul. 26, 2002. The entire teachings of the above application are incorporated herein by reference.

### BACKGROUND

Currently the telephony services available for customers are defined by telephony service providers. Typically the telephony providers offer a very limited set of telephony services and only they can create applications that access their system and provide these services. The user interface for these services is typically a set of buttons on a telephone. The users have to remember which button or sequence of buttons to press in order to make the system perform the function they need.

A different approach to providing telephony services is demonstrated by computer telephony applications which normally do not use the equipment of telephony service providers, but rather run on small and medium systems installed on the customer's premises or on application service providers' premises. Such customers have to own the telephony equipment and take care of its maintenance and support or rely on third parties to do so. This again puts the third parties in control of what applications are available. Also in this case the customers need to trust the third parties with their proprietary data, because typically the applications need to access the data. This introduces privacy and security concerns.

### SUMMARY

This invention relates to telephony services provided over the telephone network. This invention also relates to methods of managing and controlling telephony equipment over the Internet to deliver telephony services.

This invention overcomes limitations of the existing models of providing telephony services to the end users. In general, this invention provides the end user control of telephony services by opening a telephony API to control telephony systems and making the API available to the end user over the Internet. This approach allows creation of customized applications that meet the customer needs for flexible services creation while maintaining privacy and security of proprietary user data.

This invention allows the customers to use telephony enabled, client-based applications without owning or renting telephony equipment. The telephony applications can have a rich, convenient, and intuitive user interface.

This invention allows the customers to fully control their proprietary data and to run telephony applications on their premises while accessing the telephony systems over the Internet.

This invention allows the customers to run their applications and communicate with telephony equipment across corporate firewalls and network proxies.

A part of this invention is a telephony API that makes it possible to control telephony equipment over the Internet.

One embodiment of this invention is a system or a method of providing a voice service to a telephony device over a telephony network comprising sending a voice service control instruction from a client network device to a server network device over a non-local network; and executing the voice service control instruction using the server network device to control a voice service provided to the telephony device over the telephony network.

Another embodiment of this invention is a device or a method of controlling connection of a telephony device to a telephony control device on a telephony network comprising sending a call status request from a client network device to a server network device over a non-local network; sending a call status response from the server network device to the client network device over the non-local network; sending a connection control instruction from the client network device to the server network device over the non-local network; and executing the connection control instruction using the server network device to control connection of the telephony device to the telephony device over the telephony network.

Another embodiment of this invention is a device or a method of controlling connection of a telephony device to a telephony control device on a telephony network comprising: sending a call status message from a server network device to a client network device over a non-local network, the server network device being coupled to the telephony control device; sending a connection control instruction from the client network device to the server network device over the non-local network; and executing the connection control instruction using the server network device to control connection of the telephony device to the telephony device over the telephony network.

Another embodiment of this invention is a device or a method of providing a telephony service to a telephony device over a telephony network comprising: sending a telephony script from a client network device to a server network device over a non-local network; and executing the telephony script using the server network device to control the telephony services provided to the telephony device over the telephony network.

Another embodiment of this invention is a device or a method of providing a service to a telephony device over a telephony network comprising: sending control information from a client network device to a server network device over a non-local network; and processing the control information using the server network device to control a service provided to the telephony device over the telephony network.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a block diagram of an embodiment of this invention.

FIG. 2 is a control flow sequence for an inbound call.

FIG. 3 is a control flow sequence for an outbound call.

### DETAILED DESCRIPTION

A description of preferred embodiments of the invention follows.

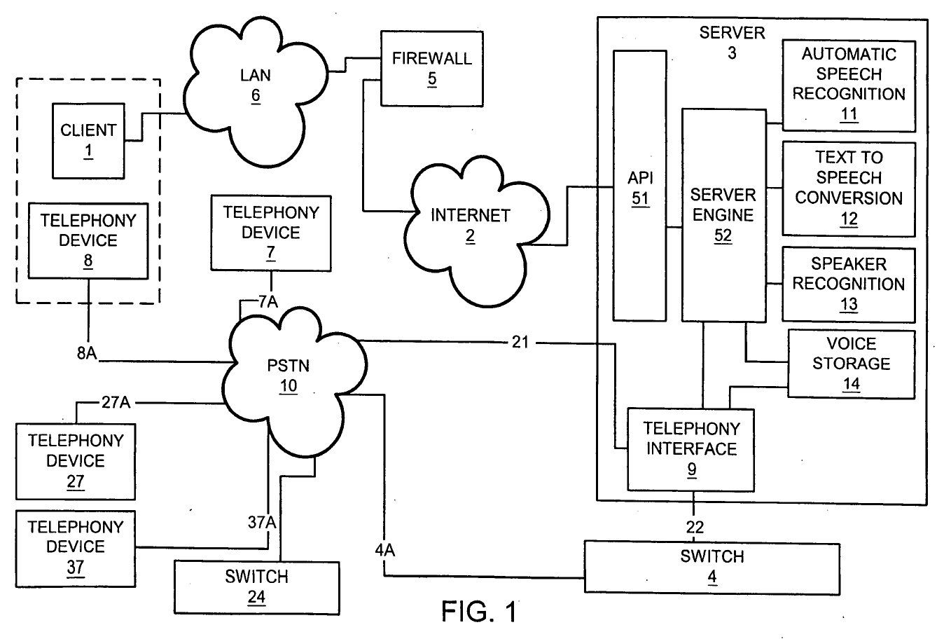

FIG. 1 shows an embodiment of this invention for managing and controlling telephony equipment over the Internet to deliver telephony services. In the configuration shown, a client computer 1, or, generally, a client network device, such as a web-enabled personal device, on a local area network 6 transmits over a non-local network 2 (e.g. the Internet) commands to be executed by a server computer 3, or another computation device communicating with the non-local network 2. These commands may be transmitted using Hypertext Transfer Protocol (HTTP) requests and the information embedded in these requests may be structured according to Extensible Markup Language (XML) requirements. These commands may require responses from the server 3, and, when the HTTP protocol is used, the responses may arrive as HTTP responses. The information carried by the HTTP requests and responses may be encrypted. In some embodiments of this invention, every communication between the client 1 and the server 3 is initiated by the client 1. Note that, for such an arrangement, the configuration of a firewall 5 controlling the connection of the client 1 to the Internet 2 requires minimal or no efforts because usually such firewalls only filter and process the HTTP requests coming from outside of the local area network 6. Another advantage of using HTTP is that it works well with unreliable Internet connections and does not require a permanent connection between the client 1 and the server 3. When the connection is lost temporarily and restored later, the HTTP can continue working. The detailed description of the communications between the client 1 and the server 3 is provided below.

The client computer 1 runs a software application which is responsible for sending commands to the server 3 and for deciding which commands to send. The client software may have a user interface showing the user of the client 1 the current status of the system and the actions available to the user, such as answering the phone, sending a message, dialing a number, or other actions. The client software may also run without user input, by executing a fixed strategy or a sequence of actions.

The server computer 3 runs a software application which functions as a server engine 52 to bring together several other software and hardware systems used for more specific functions performed by the server, such as an Application Program Interface (API) 51, a telephony interface 9, and others. These systems are described below.

The server 3 is connected to a telephony control device or a switch 4, such as a telephone switch, which controls the connections of several telephony devices, such as 7, 8, 27, and 37 to telephony network 10. The telephony control device may be embedded into the server 3. The telephony network 10 may be, for example, the Public Switched Telephone Network (PSTN), a wireless network, or Internet as used for telephony applications (e.g. voice over IP). The telephony devices 7, 8, 27, and 37 may be telephone sets, cellular phones, personal digital assistants (PDA), answering machines, voice generating devices, voice recording devices, fax machines, modems, computers capable of the above functions, or other devices. Note that all connections (4A, 7A, 8A, 27A, 37A) to the telephony network 10 may be wireless or wire line.

The switch 4 controls the connections made between some telephony devices on the telephony network 10, for example, by using SS7, S.100, or S.410 protocol on PSTN or SIP and SIP-T protocols on the Internet. The same protocols may be used to implement communications between the server 3 and the switch 4.

Depending on the needs of the environment where an embodiment of this invention is employed, the switch 4 may be a large, carrier grade system, such as a system in the central office of a telephony service provider (e.g., the local phone company), or a small telephony system such as a PBX. The switch 4 may be connected to the telephony network 10 through a number of telephone lines or high speed channels, it may be a part of the telephony network 10 such as a system in the central office of a telephony service provider, or it may be a part of the distributed switch of a wireless telephony service provider. In FIG. 1, the connection 22 between the switch 4 and the server 3 denotes the situation where the switch 4 and the server 3 are in physical proximity. On the other hand, the connection 21 is used when the switch 4 is located remotely from the server 3 and is controlled over the telephony network 10.

The server 3 uses telephony interface 9 to communicate with the switch 4, when the switch 4 is located outside the server 3. To implement the telephony interface 9, one embodiment of this invention uses a Dialogic computer telephony board and software by Intel Corp. The Dialogic software includes a server program, which runs on the server 3. This program allows access to the computer board's telephony functions via dynamic link library calls from the server engine software 52, which, in this embodiment, is a C# program using the NET Framework by Microsoft Corp. In this embodiment, the telephony interface 9 communicates with the switch 4 using the S.100 standard. In other embodiments, the telephony interface 9 may be implemented to use SS7 or S.410 for communicating with other switch configurations.

Having described the elements of the network configuration in FIG. 1, examples of telephony services provided by the network are now described.

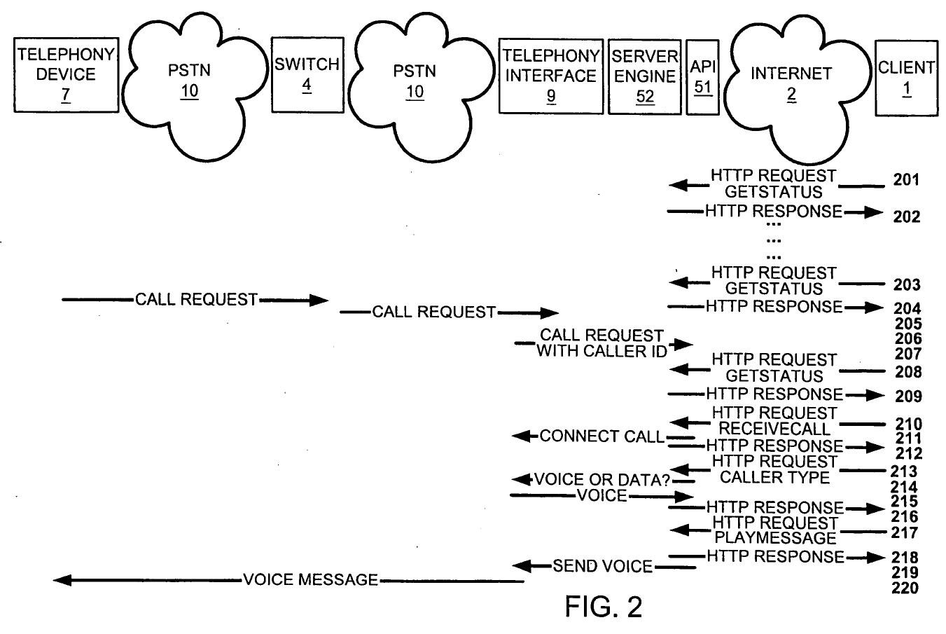

FIG. 2 shows the handling of incoming calls by one embodiment of this invention. Note that this embodiment uses a polling strategy to determine the presence of an incoming call, in other words, the client 1 periodically requests the status information from the server 3, as shown by exchanges 201-204. This exchange of information between the client 1 and the server engine 52 is passing through an Application Program Interface (API) 51, which is described in detail below.

The client 1 may have one or more telephony addresses or telephony terminal designators, such as a phone number, associated with it within the switch 4 and the server 3. The calls to such numbers are routed over the telephony network 10 to the switch 4, and the server 3 controls which phone numbers the client 1 can access. An incoming call, for example, from the telephony device 7, made to one of the client's telephone numbers is noticed by the switch 4, 205. In response, the switch 4 may be capable of simply making the connection between the telephony device 7 and the client user's telephony device 8, but this is not the normal course of events for embodiments of this invention; in this embodiment, the switch 4 informs the server 3 that an incoming call is present, 206. The server 3 in response to a client request 208 informs the client 1 over the Internet 2 about an incoming call being present 209, and may include some additional data, such as the Caller ID, into the message. This message may come in a response to a request from the client 1 thus implementing a polling strategy, as shown in FIG. 2, or, alternatively, the server 3 may itself initiate the transmission of the information about the incoming call. Note that in case of the server 3 transmitting this information as an HTTP request over the Internet 2, the user of the client computer 1 may need to configure the firewall 5 to allow transmission of HTTP requests from outside of the LAN 6. Additionally, the server 3 even before informing the client 1 about the incoming call may establish a connection between the telephony device 7 and a telephony interface 9, for example, to play a message or music while the telephony device 7 waits for connection.

Upon determining that there is an incoming call and based on the additional information about the call, e.g. the Caller ID of the calling party, if such information is available, the client 1 determines how to proceed and sends an appropriate command to the server 3. The determination of the next step to be taken by the client 1 may be made automatically by the software running on the client 1 or after the client 1 informs its human user about the incoming call and the human user makes the decision about how to proceed.

The next step may be to make a connection between the device 7 and the interface 9, 210, 211, and 212, and to determine the type of signal coming from the device 7, voice or data, 213, 214, 215, and 216. This determination may be made by the combination of the server engine 3, switch 4, and telephony interface 9 (which may physically be components of the same electronic device). And again, the client 1 sends a request for this information 213 and the server 3 sends the information in its response 216. Based on this information and optionally on the human user's input, the client 1 determines the next step for the server 3 to make and sends it an appropriate command. The detailed discussion of such commands will be provided below.

FIG. 2 shows the situation when the user of the client 1 does not want to pick up the phone and wants to send a voice message to the caller. The client 1 requests that the server 3 play a stored voice message to the caller using the device 7. This request 217 is received by API 51 and subsequently 219 the server engine 52 uses the telephony interface 9 and the voice storage 14 (see FIG. 1) to send the message 202 to the device 7 (see FIG. 2).

As noted, the user of the client 1 may have more than one telephone number associated with it. These numbers may be associated with different switches on the telephony network 10. Some of these switches do not have to be controlled by the server 3. For example, if a call is made from the telephony device 37 to the user's number such that the first switch handling it is switch 24, the call will be forwarded or routed to the switch 4 which is controlled by the server 3. The client 1 may have more than one telephony device associated with it and the client may issue commands to the server 3 to implement its choice of to which telephony device the incoming call should be directed.

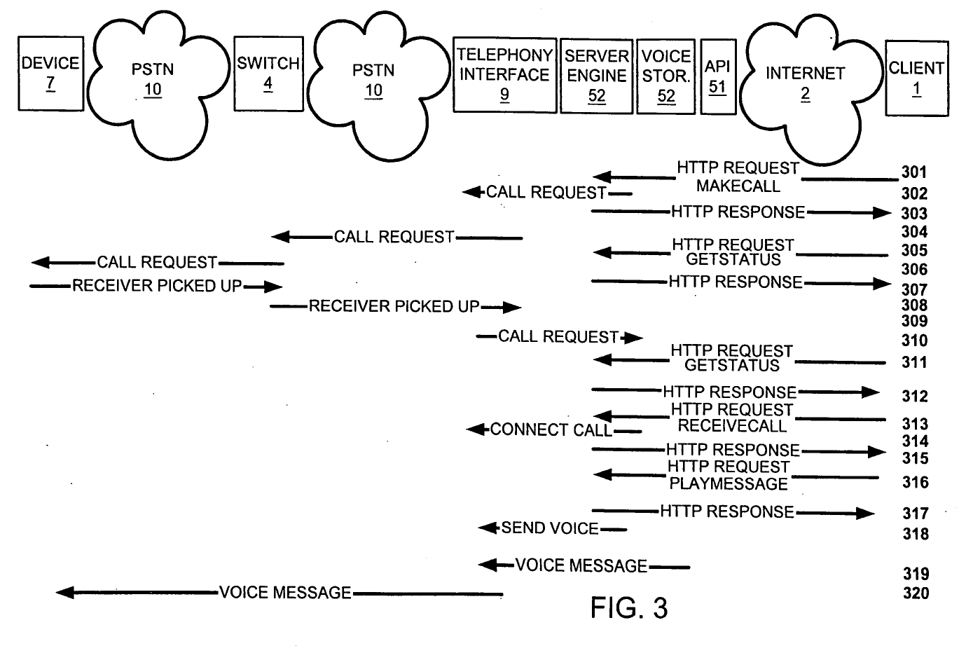

FIG. 3 shows the sequence of events in an embodiment of this invention for handling outbound calls wherein the client 1 initiates sending the user of the device 7 a voice message stored in a voice storage 14. The client sends a command to the server, 301, which sends a command 302 to the telephony interface 9 to establish a connection with the device 7 and sends a response to the client 1, 303. The telephony interface sends the command 304 to the switch 4 to ring the phone 7, 306. During this time the client 1 periodically checks the status of the connection using Get Status requests and responses, 305 and 307. After the user of the device 7 picks up the receiver, the switch 4 notices it 308, and informs the telephony interface about it, 309. After the server engine receives this information, 310, in response 312 to the next status request 311, it informs the client that the phone has been picked up. The client requests, 313, that the connection is made 314, and that a message is sent to the device 7, 316, 317, 318, 319, 320.

In addition to outbound and inbound call control, the server 3 also may provide to the client a variety of services such as storage of voice mail, receiving and sending of faxes, etc. some of which require the appropriate software engines to reside on the server. For example, for speech services which may include, as shown in FIG. 1, automatic speech recognition 11, text to speech conversion 12, and/or speaker recognition 13, embodiments of this invention may use the following software packages: speech recognition, text-to-speech, and speaker verification products from SpeechWorks International, Inc., such as OpenSpeech, Speechify, and SpeechSecure; speech recognition, voice authentication, and text-to-speech products from Nuance Communications Inc., such as Nuance, Vocalizer, and Verifier; automatic speech recognition and text-to-speech products from ScanSoft, Inc., such as SpeechPearl and RealSpeak; or Open Source speech recognition software from Carnegie Mellon University, such as Sphinx-2 and Sphinx-3.

The following Application Program Interface (API) may be used in an embodiment of this invention for communications between the client 1 and the server 3. The API service provided by the server 3 to the client 1 in this embodiment is called w2t. The commands issued by the client 1 take the form of invocation of methods through XML information embedded in HTTP messages. All methods in this API are non-blocking unless specified otherwise. In embodiments where this interface is used, the actual status after such calls is obtained after a method has been invoked. To obtain the status, the client calls the GetStatus method. The methods expect parameters and return results in a form of XML strings, except few functions that take and return binary data in the form of byte arrays. The following description of the API methods also lists some of the calls being made by the server engine 52 to the telephony interface 9.

Get Public Key

This method allows a client to obtain a w2t public key for encryption of data sent to the service.

Returns:

<results>

<public_key
type=”string”><![CDATA[...key...value...]]></public_key>

</results>

Set Public Key

This method allows a client to provide the w2t with its own public key for encryption of the data that is sent to the client from w2t.

Arguments:

<arguments>

<public_key
type=”string”><![CDATA[...key...value...]]></public_key>

</arguments>

Authenticate

This method takes the credentials of the client and verifies them against an account database, accessible by the server. The arguments include a list of resources that the client is planning to use in this session. Based on this resource list, the service performs the client authorization. This resource list becomes the default resource list for the session. If one or more consecutive commands require a list of resources, and the client does not provide it, the default resource list is used.

The list of resources may include only the resources the client is allowed to access. If the authenticate command does not contain a list of resources, the entire list of resources allowed to the client becomes the default list for the session.

If the authentication and authorization succeed, a new session is created. The session id (a global user id, guid) is returned to the client.

Arguments:

<arguments type=”xml” encrypted=”false”>

<account_name type=“string”
encrypted=”false”>my_account</account_name>
<password type=“string” encrypted=”false”>my_password</
password>
<resource_list type=”xml”>

<outbound_line_count type=”int”>15</outbound_line_count>
<tts_channels_count type=”int”>10</tts_channels_count>
<inbound_lines type=”xml”>

<number type=“xml” encrypted=“false”>

<main type=“string”
encrypted=“false”>18883332211</main>

<extension type=“string”
encrypted=“false”>502</extension>

</number>

</inbound_lines>

</resource_list>

</arguments>
Returns:
<results type=”xml” encrypted=”false”>

<status type=”string” encrypted=”false”>succeeded</status>
<session_id type=”string” encrypted=”false”>

93FB0CBF-AF29-4d85-9E3E-F014FE163E51

</session_id>

</results>

Telephony Interface Calls

In an embodiment of this invention using a Dialogic computer telephony board and software by Intel Corp., this API method is processed by the server engine to invoke:

CTses_Create( )

Kill Session

This method must be called at the end of user's session to disconnect from w2t and release the allocated resources. It only needs the current session ID as an argument.

Arguments:

<arguments type=“xml” encrypted=”false”>

<session_id type=”string” encrypted=”false”>

93FB0CBF-AF29-4d85-9E3E-F014FE163E51

</session_id>

</arguments>
Returns:
<results type=”xml” encrypted=”false”>

<status type=“string” encrypted=“false”>succeeded</status>

</results>

Keep Session

This method is called periodically by the client to keep the session alive. Sessions will expire after a timeout interval, configured for the server. Typically, this interval is 30 minutes. An expired session will terminate all its connections and clean up its resources. If the client needs to keep a session alive, it has to call this method before the session expires. The argument is the session id. One returned value of this method is the time interval after which the session will expire. Another value is the minimum interval within which the client cannot call this method again (to prevent clients from constantly calling this method and overloading the server). If the client calls this method before the minimum interval has expired, the session is cleaned up, its resources are released, and its calls are terminated.

<arguments type=“xml” encrypted=”false”>

<session_id type=”string” encrypted=”false”>

93FB0CBF-AF29-4d85-9E3E-F014FE163E51

</session_id>

</arguments>

Returns:

<results type=”xml” encrypted=”false”>

<expire_interval type=”int” units=”sec”>1800</expire_interval>
<min _repeat_interval type=”int” units=”sec”>900</
min_repeat_interval>

</results>

Make Call

This method allows a client to make a call to a destination. This is a non-blocking call, which returns a call id. The outcome of the call is obtained by calling the Get Status method. The Make Call method returns the call id, which may be used to obtain the status. The session id, returned by the previous call to the Authenticate method, is supplied as an argument. As an optional argument, the id a message previously uploaded to the server may be specified. This message is stored on the server within the memory allocated for the session and is be played to the destination telephony device when the connection is established. If the message delay argument is supplied, the message is played after the specified number of seconds.

Arguments:

<arguments type=“xml” encrypted=“false”>

<session_id type=“string” encrypted=”false”>

93FB0CBF-AF29-4d85-9E3E-F014FE163E51

</session_id>
<number type=“xml” encrypted=“false”>

<main type=“string” encrypted=“false”>18885552211</main>
<extension type=“string” encrypted=“false”
delay=“3”>502</extension>

</number>
<message_id type=“string” encrypted=“false” delay=“2”>

17DB8980-9EA0-4c6f-8796-99559D8ABBCA

</message_id>

</arguments>

Returns:

<results type=“xml”>

<status type=“string” encrypted=“false”>succeeded</status>
<call_id type=”string” encrypted=“false”>

899BC712-4C49-4859-AB1C-4D716292E292

</call_id>

</results>

Telephony Interface Calls

In an embodiment of this invention using a Dialogic computer telephony board and software by Intel Corp., this API method is processed by the server engine to invoke:

CTscr_MakeCallo

CTsg_SendSignals( )

newCTtranInfo( )

Ctplyr_Play( )

Receive Call

This method tells the w2t service to expect a call at a specified telephone number. An incoming call will be answered. The telephone number must previously be assigned to the client's account. If the account does not have an assigned number for incoming calls or if this resource had not been requested when the session was created, the request is rejected. This is a non-blocking call and the result should be requested by calling the GetStatus call. The method will return the call id, which may be used for obtaining the status of the call.

As an optional argument, a previously loaded message id may be specified. This message is stored on the server within the memory allocated for the session and is played to the destination telephony device when the connection is established.

Arguments:

<arguments type=“xml”>

<session_id type=“string” encrypted=“false”>

93FB0CBF-AF29-4d85-9E3E-F014FE163E51

</session_id>
<number type=“xml” encrypted=“false”>

<main type=“string”>8885557744</main>
<extension type=“string”>3457</extension>

</number>
<message_id type=“string” encrypted=“false” delay=“2”>

17DB8980-9EA0-4c6f-8796-99559D8ABBCA

</message_id>

</arguments>
Returns:
<results type=“xml”>

<status type=“string” encrypted=“false”>succeeded</status>
<call_id type=”string” encrypted=“false”>

899BC712-4C49-4859-AB1C-4D716292E292
</call_id>

</results>

Telephony Interface Calls

In an embodiment of this invention using a Dialogic computer telephony board and software by Intel Corp., this API method is processed by the server engine to invoke:

CTscr_RequestGroup( )

Get Status

This call allows the client to obtain the status of a certain entity or the status of the entire session. To obtain the status of a call or a conference the appropriate id must be specified. If no id's are specified, the status of the entire session is returned.

<results type=”xml” encrypted=”false”>

<min_repeat_interval type=”int” uints=”msec”>1000</
min_repeat_interval>

</results>

This method takes an optional list of resources and returns current status of each of them. If the list of resources is not provided, the status of the entire session and all resources allocated for the current session is returned. This method may not be called more often then a minimum repeat interval. The value of this interval is a part of the returned data and is specified in milliseconds. If the method is called before the minimum repeat interval expires, all session resources are released and the session is destroyed. The format of the status depends on the type of each resource. The following request returns the statuses of all resources within the session:

<arguments type=“xml” encrypted=”false”>

<session_id type=”string” encrypted=”false”>

93FB0CBF-AF29-4d85-9E3E-F014FE163E51
</session_id>
</arguments>

Returns:

<results type=”xml” encrypted=”false”>

<status type=“string” encrypted=“false”>succeeded</status>
<min_repeat_interval type=”int” units=”msec”>1000</ min_{—}
repeat_interval>
<session_status type=”xml” encrypted=”false”>

<expire_interval type=”int” units=”sec”>1800</expire_{—}
interval>
<min_repeat_interval type=”int” units=”sec”>900</

min_repeat_interval>

</session_status>

<call_status type=”xml” encrypted=”false”>

<call_id type=”string” encrypted=”false”>

73FA0CXF-AF62-4d85-9E0E-F053FE813E25

</call_id>
<status type=”string” encrypted=”false”>

in progress
</status>
</call_status>
</results>

The following request behaves the same way as Keep Session does:

<arguments type=“xml” encrypted=”false”>

<session_id type=”string” encrypted=”false”>

93FB0CBF-AF29-4d85-9E3E-F014FE163E51

</session_id>
<session_status_only type=”bool”>true</session_status_only>

</arguments>

Returns:

<results type=”xml” encrypted=”false”>

<status type=“string” encrypted=“false”>succeeded</status>
<min_repeat_interval type=”int” units=”msec”>1000</ min_{—}
repeat_interval>
<session_status type=”xml” encrypted=”false”>

<expire_interval type=”int” units=”sec”>1800</expire_{—}
interval>
<min_repeat_interval type=”int” units=”sec”>900</

min_repeat_interval>

</session_status>

</results>

And finally an example with a selective list of resources, previously allocated for the session.

<arguments type=“xml” encrypted=”false”>

<session_id type=”string” encrypted=”false”>

93FB0CBF-AF29-4d85-9E3E-F014FE163E51
</session_id>
<status_resource_list type=”xml” encrypted=”false”>

<tts_id type=”string” encrypted=”false”>

28FA0SXU-AE62-4d85-9E0E-F053GL813E74
</tts_id>

<call_id type=”string” encrypted=”false”>

73FA0CXF-AF62-4d85-9E0E-F053FE813E25

</call_id>

<session/>

</status_resource_list>
</arguments>

Returns:

<results type=”xml” encrypted=”false”>

<status type=“string” encrypted=“false”>succeeded</status>
<min_repeat_interval type=”int” units=”msec”>1000</ min_{—}
repeat_interval>

<session_status type=”xml” encrypted=”false”>

<expire_interval type=”int” units=”msec”>1800</expire_{—}
interval>
<min_repeat_interval type=”int” units=”msec”>900</

min_repeat_interval>
</session_status>
<call_status type=”xml” encrypted=”false”>

<call_id type=”string” encrypted=”false”>

73FA0CXF-AF62-4d85-9E0E-F053FE813E25

</call_id>
<status type=”string” encrypted=”false”>

disconnected

</status>

</call_status>
<tts_status type=”xml” encrypted=”false”>

<tts_id type=”string” encrypted=”false”>

28FA0SXU-AE62-4d85-9E0E-F053GL813E74
</tts_id>

<status type=”string” encrypted=”false”>

idle
</status>
</tts_status>
</results>

Load Message

This method allows user to load an audio message into his or her session to use later to play into the phone line for an individual caller or a conference. In addition to the required session ID, this method may also take a binary image of the audio message, a text to convert into audio using TTS, or a call ID to record a message from the phone line and returns an ID for the message. User uses this ID to reference this message later in the session.

Arguments:

<arguments type=”xml” encryption=”false”>

<session_id type=”string” encrypted=”false”>

93FB0CBF-AF29-4d85-9E3E-F014FE163E51

</session_id>
<message type=”tts” encryption=”false”>

Welcome to the Demo conference.

</message>

</arguments>

or:

<arguments type=”xml” encryption=”false”>

<session_id type=”string” encrypted=”false”>

93FB0CBF-AF29-4d85-9E3E-F014FE163E51

</session_id>
<message type=”uunet” encryption=”false”>

01AJNCB4985JSZSO93W4SO943ASHDW73
4SNS743HGDSDKISE985BV89O34FBCV9Q
34BQ3F89H34FO98FBVCO9834FBVO983H
4FKAERV9834FKFVHZE985T2B45RGO98H
W34TKBSEO98U345GBSEO9R8HVF34JFBO
A98HVKB3498H349585U234GHAEO98VHQ
34F

</message>

</arguments>

or:

<arguments type=”xml” encryption=”false”>

<session_id type=”string” encrypted=”false”>

93FB0CBF-AF29-4d85-9E3E-F014FE163E51

</session_id>
<message type=”call” encryption=”false”>

<call_id type=”string” encrypted=”false”>

73FA0CXF-AF62-4d85-9E0E-F053FE813E25

</call_id>
<time_out type=”int” units=”sec”>8</time_out>
<max_length type=”int” units=”sec”>120</max_length>

</message>

</arguments>

Returns:

<results type=“xml”>

<status type=“string” encrypted=“false”>succeeded</status>
<message_id type=”string” encrypted=“false”>

899BC712-4C49-4859-AB1C-4D716292E292

</message_id>

</results>

Discard Message

This method allows the user to discard a message from a session to free storage from messages what are not going be used anymore. It takes a message ID in addition to the required session ID.

Arguments:

```
<arguments type=”xml” encryption=”false”>
    <session_id type=”string” encrypted=”false”>
93FB0CBF-AF29-4d85-9E3E-F014FE163E51
    </session_id>
    <message₋id type=”string” encrypted=”false”>
        899BC712-4C49-4859-AB1C-4D716292E292
    </message₋id>
</arguments>
```

Returns:

<results type=“xml”>
<status type=“string” encrypted=“false”>succeeded</status>
</results>

Play Message

This method allows the user to play an audio message into a phone line. It expects a message ID, DTMF sequence or any parameters accepted by Load Message method. In the later case a temporary message will be created for the duration of the command.

Arguments:

```
<arguments type=”xml” encryption=”false”>
    <session_id type=”string” encrypted=”false”>
93FB0CBF-AF29-4d85-9E3E-F014FE163E51
    </session_id>
    <message type=”tts” encryption=”false”>
        Welcome to Demo conference.
    </message>
</arguments>
```

or:

```
<arguments type=”xml” encryption=”false”>
    <session_id type=”string” encrypted =”false”>
93FB0CBF-AF29-4d85-9E3E-F014FE163E51
    </session_id>
    <message type=”dtmf” encryption=”false” delay=”2”>
        139756,,2493,5238
    </message>
</arguments>
```

or:

```
<arguments type=”xml” encryption=”false”>
    <session_id type=”string” encrypted=”false”>
93FB0CBF-AF29-4d85-9E3E-F014FE163E51
    </session_id>
    <message type=”uunet” encryption=”false”>
01AJNCB4985JSZSO93W4SO943ASHDW73
4SNS743HGDSDKISE985BV89O34FBCV9Q
34BQ3F89H34FO98FBVCO9834FBVO983H
4FKAERV9834FKFVHZE985T2B45RGO98H
W34TKBSEO98U345GBSEO9R8HVF34JFBO
A98HVKB3498H349585U234GHAEO98VHQ
34F
    </message>
</arguments>
```

or:

```
<arguments type=”xml” encryption=”false”>
    <session_id type=”string” encrypted=”false”>
93FB0CBF-AF29-4d85-9E3E-F014FE163E51
    </session_id>
    <message_id type=”string” encrypted=”false”>
        899BC712-4C49-4859-AB1C-4D716292E292
    </message_id>
</arguments>
```

Returns:

<results type=“xml”>
<status type=“string” encrypted=“false”>succeeded</status>
</results>

Create Conference

This method may be used for creation of a conference. The conference may be used to connect two or more calls. The conference id is returned by the method. This id may be used to join calls to the conference. This method is a non-blocking method and actual results must be obtained by calling the Get Status method. Phone numbers may be supplied to the method as optional arguments. These numbers are called and joined to the conference. As an optional argument, a previously loaded message id (see data control methods) may be specified. This message is stored on the server within the memory allocated for session and is played when a call joins the conference. If specified, such a message is played to joining party. Messages may be specified for all participants or only for some of them individually.

Arguments:

```
<arguments type=“xml”>
    <session_id” type“string” encrypted=”false”>
        93FB0CBF-AF29-4d85-9E3E-F014FE163E51
    </session_id>
    <max_capacity>7</max_capacity>
    <message_id type=“string” encrypted=“false” delay=“2”>
        17DB8980-9EA0-4c6f-8796-99559D8ABBCA
    </message_id>
    <participant_list type=“xml”>
        <participant type=“xml”>
            <number type=“xml” encrypted=“false”>
                <main type=“string”
                encrypted=“false”>18883332211</main>
                <extension type=“string” encrypted=“false”
                delay=“3”>501</extension>
            </number>
            <message_id type=“string” encrypted=“false” delay=“2”>
                36DK8280-9ES5-4c6f-8796-99559D8ABKEB
            </message_id>
        </participant>
        <participant type=“xml”>
            <number type=“xml” encrypted=“false”>
                <main type=“string”
                encrypted=“false”>18883332211</main>
                <extension type=“string” encrypted=“false”
                delay=“3”>502</extension>
            </number>
        </participant>
        <participant type=“xml”>
            <number type=“xml” encrypted=“false”>
                <main type=“string”
                encrypted=“false”>18883332211</main>
                <extension type=“string” encrypted=“false”
                delay=“3”>503</extension>
            </number>
            <message_id type=“string” encrypted=“false” delay=“2”>
                17DB8980-9EA0-4c6f-8796-99559D8ABBC8
            </message_id>
        </participant>
    </participant_list>
</arguments>
```

Returns:

```
    <results type=“xml”>
        <status type=“string” encrypted=“false”>succeeded</status>
        <conference_id type=“string” encrypted=“false”>
            899BC712-4C49-4859-AB1C-4D716292E292
        </conference_id>
        <call type=“xml”>
        <call_id type=“string” encrypted=“false”>
            899BC712-4C49-4859-AB1C-4D716292E292
        </call_id>
        <number type=“xml” encrypted=“false”>
            <main type=“string”
            encrypted=“false”>18883332211</main>
            <extension type=“string”
            encrypted=“false”>501</extension>
        </number>
    </call>
    <call type=“xml”>
        <call_id type=“string” encrypted=“false”>
            899BC712-4C49-4859-AB1C-4D716292E293
        </call_id>
        <number type=“xml” encrypted=“false”>
            <main type=“string”
            encrypted=“false”>18883332211</main>
            <extension type=“string”
            encrypted=“false”>502</extension>
        </number>
    </call>
    <call type=“xml”>
        <call_id type=“string” encrypted=“false”>
            899BC712-4C49-4859-AB1C-4D716292E294
        </call_id>
        <number type=“xml” encrypted=“false”>
            <main type=“string”
            encrypted=“false”>18883332211</main>
            <extension type=“string”
            encrypted=“false”>503</extension>
        </number>
    </call>
</results>
```

Join Conference

This method is called to join an existing call to a previously created conference. A message may be specified to be played to the joining party. Arguments of the method include the session ID, conference ID, call ID and an optional message ID.

Arguments:

```
<arguments type=“xml”>
    <session_id” type=“string” encrypted=“false”>
        93FB0CBF-AF29-4d85-9E3E-F014FE163E51
    </session_id>
    <conference_id type=“string” encrypted=“false”>
        899BC712-4C49-4859-AB1C-4D716292E292
    </conference_id>
    <call_id type=“string”>
        899BC712-4C49-4859-AB1C-4D716292E292
    </call_id>
    <message_id type=“string” encrypted=“false” delay=“2”>
        17DB8980-9EA0-4c6f-8796-99559D8ABBC8
    </message_id>
</arguments>
```

Returns:

<results type=“xml”>
<status type=“string” encrypted=“false”>succeeded</status>
</results>

Leave Conference

A call that participates in a conference may leave it. The connection to the conference participants is broken, but the connection to the remote number stays, so that the call may be joined to another conference or to other functionality, e.g., to message play/record.

Arguments:

```
<arguments type=“xml”>
    <session_id” type=“string” encrypted=”false”>
        93FB0CBF-AF29-4d85-9E3E-F014FE163E51
    </session_id>
    <conference_id type=“string” encrypted=“false”>
        899BC712-4C49-4859-AB1C-4D716292E292
    </conference_id>
    <call_id type=“string” >
        899BC712-4C49-4859-AB1C-4D716292E292
    </call_id>
</arguments>
```

Returns:

<results type=“xml”>
<status type=“string” encrypted=“false”>succeeded</status>
</results>

Hang Up

The remote party is disconnected, the call is removed from conferences and the resources are released.

Arguments:

```
<arguments type=“xml”>
    <session_id” type=“string” encrypted=”false”>
        93FB0CBF-AF29-4d85-9E3E-F014FE163E51
    </session_id>
    <call_id type=“string”>
        899BC712-4C49-4859-AB1C-4D716292E292
    </call_id>
</arguments>
```

Returns:

<results type=“xml”>
<status type=“string” encrypted=“false”>succeeded</status>
</results>

Destroy Conference

When a conference is destroyed the remote parties are disconnected, call resources are released and the conference is destroyed. It is possible to specify that some calls are not terminated.

Arguments:

```
<arguments type=“xml”>
    <session_id” type=“string” encrypted=“false”>
        93FB0CBF-AF29-4d85-9E3E-F014FE163E51
    </session_id>
    <conference_id type=“string” encrypted=“false”>
        899BC712-4C49-4859-AB1C-4D716292E292
    </conference_id>
    <hangup_all_calls type=“bool”>true</hangup_{—}
    all_calls>
    <keep_calls type=“xml”>
    <call_id type=“string”>
        899BC712-4C49-4859-AB1C-4D716292E292
    </call_id>
    <call_id type=“string”>
        899BC712-4C49-4859-AB1C-4D716292E295
    </call_id>
    </keep_calls>
</arguments>
```

Returns:

<results type=“xml”>
<status type=“string” encrypted=“false”>succeeded</status>
</results>

The following demonstrates the sequence of method calls and results, a client may perform to create a conference call.

Call Athenticate with the following arguments:

```
<arguments type=“xml”>
<account_name type=“string” encrypted=“false”>my_{—}
account</account_name>
<password type=“string” encrypted=“false”>my_password</password>
<resource_list type=“xml”>
    <outbound_lines count=“15/>
    <tts_channels_count type=“int”>15</tts_channels_count>
</resource_list>
</arguments>
```

The method returns:

```
<results type=“xml”>
    <status type=“string”>succeeded</status>
    <session_id type=“string”>
        93FB0CBF-AF29-4d85-9E3E-F014FE163E51
    </session_id>
</results>
```

Call LoadMessage to load a greeting message for moderator of the conference call:

```
<arguments type=“xml”>
    <session_id type=“string”>
        93FB0CBF-AF29-4d85-9E3E-F014FE163E51
    </session_id>
    <message type=“tts” encryption=“false”>
        Welcome to the annual revenue review conference.
        You will be a moderator of this conference call.
        Please wait while other parties are being contacted.
    </message>
</arguments>
```

The method returns:

```
<results type=“xml”>
    <status type=“string”>succeeded</status>
    <message_id type=“string”>
        899BC712-4C49-4859-AB1C-4D716292E292
    </message_id>
</results>
```

Call LoadMessage to load a greeting message for non-moderator participants of the conference call:

```
<arguments type=“xml”>
    <session_id type=“string”>
        93FB0CBF-AF29-4d85-9E3E-F014FE163E51
    </session_id>
    <message type=“tts” encryption=“false”>
        Welcome to the annual revenue review conference.
    </message>
</arguments>
```

The method returns:

```
<results type=“xml”>
    <status type=“string”>succeeded</status>
    <message_id type=“string”>
        909BC712-4C49-4859-AB1C-4D716292E203
    </message_id>
</results>
```

Call CreateConference to create a conference call:

```
<arguments type=“xml”>
    <session_id” type=“string”>
        93FB0CBF-AF29-4d85-9E3E-F014FE163E51
    </session_id>
    <max_capacity>10</max_capacity>
    <message_id type=“string” delay=“2”>
        909BC712-4C49-4859-AB1C-4D716292E203
    </message_id>
    <participant_list type=“xml”>
        <participant type=“xml”>
            <number type=“xml”>
                <main type=“string”>18883332211</main>
                <extension type=“string” delay=“8”>5</extension>
                <extension type=“string” delay=“3”>01</extension>
            </number>
            <message_id type=“string”delay=“2”>
                    899BC712-4C49-4859-AB1C-4D716292E292
            </message_id>
        </participant>
        <participant type=“xml”>
            <number type=“xml”>
                <main type=“string”>18883332211</main>
                <extension type=“string” delay=“3”>502</extension>
            </number>
        </participant>
        <participant type=“xml”>
            <number type=“xml”>
                <main type=“string”>18883332211</main>
                <extension type=“string” delay=“13”>50</extension>
                <extension type=“string” delay=“5”>3</extension>
            </number>
        </participant>
    </participant_list>
</arguments>
```

The method returns:

```
<results type=“xml”>
    <status type=“string”>succeeded</status>
    <conference_id type=“string”>
        239BC712-4C49-4859-AB1C-4D716292E234
    </conference_id>
    <call type=“xml”>
        <call_id type=“string”>
            899BC712-4C49-4859-AB1C-4D716292E292
        </call_id>
        <number type=“xml”>
            <main type=“string”>18883332211</main>
            <extension type=“string” delay=“8”>5</extension>
            <extension type=“string” delay=“3”>01</extension>
        </number>
    </call>
    <call type=“xml”>
        <call_id type=“string”>
            899BC712-4C49-4859-AB1C-4D716292E293
        </call_id>
        <number type=“xml”>
            <main type=“string”>18883332211</main>
            <extension type=“string” delay=“3”>502</extension>
        </number>
    </call>
    <call type=“xml”>
        <call_id type=“string”>
            899BC712-4C49-4859-AB1C-4D716292E294
        </call_id>
        <number type=“xml”>
            <main type=“string”>18883332211</main>
            <extension type=“string” delay=“13”>50</extension>
            <extension type=“string” delay=“5”>3</extension>
        </number>
    </call>
</results>
```

Call MakeCall to call a user to join the conference:

```
<arguments type=“xml”>
    <session_id” type=“string”>
        93FB0CBF-AF29-4d85-9E3E-F014FE163E51
    </session_id>
    <number type=“xml”>
        <main type=“string”>18883332211</main>
        <extension type=“string” delay=“3”>505</extension>
    </number>
    <message_id type=“string” delay=“2”>
        909BC712-4C49-4859-AB1C-4D716292E203
    </message_id>
</arguments>
```

The method returns:

```
<results>
<call type=“xml”>
        <status type=“string” encrypted=“false”>succeeded</status>
        <call_id type=“string” encrypted=“false”>
            659BC712-4C49-4859-AB1C-4D716292E254
        </call_id>
</call>
</results>
```

Call JoinConference to join the new user to the conference:

```
<arguments type=“xml”>
    <session_id” type=“string”>
        93FB0CBF-AF29-4d85-9E3E-F014FE163E51
    </session_id>
    <conference_id type=“string”>
        239BC712-4C49-4859-AB1C-4D716292E234
    </conference_id>
    <call_id>
        659BC712-4C49-4859-AB1C-4D716292E254
    </call_id>
    <message_id type=“string” encrypted=“false” delay=“2”>
        909BC712-4C49-4859-AB1C-4D716292E203
    </message_id>
</arguments>
```

The method returns:

<results type=“xml”>
<status type=“string” encrypted=“false”>succeeded</status>
</results>

Call DestroyConference to drop the conference:

```
<arguments type=“xml”>
    <session_id” type=“string”>
        93FB0CBF-AF29-4d85-9E3E-F014FE163E51
    </session_id>
    <conference_id type=“string”>
        239BC712-4C49-4859-AB1C-4D716292E234
    </conference_id>
<hangup_all_calls type=“bool”>true</hangup_{—}
all_calls>
</arguments>
```

The method returns:

<results type=“xml”>
<status type=“string”>succeeded</status>
</results>

Call KillSession to end the session and release the resources:

```
<arguments type=“xml” encrypted=”false”>
    <session_id type=”string” encrypted=”false”>
        93FB0CBF-AF29-4d85-9E3E-F014FE163E51
    </session_id>
</arguments>
```

The method returns:

<results type=”xml” encrypted=”false”>
<status type=“string” encrypted=“false”>succeeded</status>
</results>

Similarly structured messages may be used to implement voice processing commands, fax processing functionality, and other services available to a client computer and its users.

Using HTTP protocol for communications between client applications may introduce delays and increase the load on the server's Internet interface. To reduce these effects, an embodiment of this invention uses dynamic program uploading (DPU) to upload telephony scripts onto the server for subsequent execution. Instead of sending control messages directly to the server and receiving the results of each control message, the W2T client application generates a program fragment based on its application logic and the actions it needs to perform at the moment. This program fragment consists of some data, required action specifications and local program branching logic (to be performed on the server) concerning these W2T actions and possible events. The application uploads this program fragment and it gets executed on the server site.

The server interprets the instructions in the program fragment and generates the status and result block, which is stored on the server site within the client's session. The contents of the result block and instructions on its creation are specified in the Uploaded Program Fragment (UPF) sent by the client.

Each uploaded program fragment has a unique id, assigned by the client application. The application periodically polls the W2T server to check upon the UPF execution status and results. Until the results are available, the UPF status returned to the client application is “in-progress”. Once the UPF execution is completed, the status becomes “completed”, and the result block is returned to the client.

The client application that uploaded the UPF does not have to wait for its completion; it can execute some other actions based on the application logic. For example, it can upload more UPFs both related and unrelated to the ones that are being executed.

W2T server can store UPFs (if so is specified by the client) within the client's session and the client can request their execution at a later time without the need to generate and upload them again. Typically it would be the most common actions that can be repeated more then once.

W2T services manipulate client's data. The data may be voice messages, fax messages, results of Text To Speech conversion commands, etc. W2T server allows the clients to store the data within a session. The data may be either generated during the process of using W2T services or uploaded by the client. Each unit of data is assigned a unique ID by which it can be later accessed.

The following methods are necessary to implement the script upload services.

UploadProgram

This method takes a session ID, a program fragment ID, and the code of the program fragment. The program fragment code is an XML based data that describe actions and the logic the server must perform. The program fragment ID is a GUID (Globaly Unique Identifier—a string in the format: d8b4488b-83e1-4ab1-8948-eaf73801421d). The program fragment ID is generated by the client application. There are standard libraries and algorithms for GUID generation that client applications can use.

UploadData

This method takes a session ID, data ID, data type and the binary data (an array of bytes) to store within the session. Data ID is a GUID, which is widely used in the industry. The data ID is generated by the client application. When the session times out, all data stored within it is destroyed.

UploadGrammar

This method takes a session ID, data ID (GUID generated by the client) and a text data that contain the grammar definition.

Download Data

This method takes a session ID, data ID and returns binary data (an array of bytes), stored in the session. The data ID is a GUID. The data ID is known to the client application and returned by previous calls to the W2T API methods.

GetStatus

This method allows the client applications to receive the status of UPF execution and server resources that belong to a session. The session ID must be specified. The client can specify particular UPF IDs or resource IDs it is interested in. If no ID is specified, the entire session status is returned (all UPFs and resources in the session). The clients may poll W2T server for status when they expect some events. To prevent server overloading and unnecessary network traffic, the minimal interval they can repeat the GetStatus calls is specified in the returned data. If no activities from the client side happens, the W2T server expires a session after some timeout period. This timeout period is also returned to the client as a part of the status data.

The following is an example of a program fragment that may be uploaded to the W2T server.

This UPF makes a call and checks whether the call has succeeded. If the call has succeeded, it plays a pre-loaded prompt (voice recording). The voice recording playback may be interrupted by the user. The UPF specifies that an interruptions may be one of the following: hang up, timeout, pressing a key on the dial pad (DTMF) or speech. If the user interrupts the playback by the speech, the server will try to recognize the speech according with the specified grammars. The grammars may be pre-loaded to the server or specified in-line. The program fragment analyzes the interruption event and performs actions supplied for each of them. If the user chooses a valid option, another program fragment (specified by its ID) is executed. The results of the program fragment are stored in the session and can be requested by the client through the GetStatus method.

```
<program prog_id=“e609886f-7830-4a82-a380-c9aa00526532” name=“main_dialog_1”
store=“false”>
    <action type=“make_call” number=“6175941501” event_id=“2bf851cb-f7b6-
4884-a3ec-00b12c394f23” call_name=“first” call_id=“1037c966-be6d-4fcf-950f-
13e3139d2426”/>
    <if call=“1037c966-be6d-4fcf-950f-13e3139d2426” status=“succeeded”>
        <!-- play pre-loaded prompt -->
        <action type=“play_prompt” name=“main_menu” prompt_id=“_u57
?022d41-5c49-414a-9d39-f21c3b3f7760”>
            <event type=“hang_up”>
                <case_id>hang_up</case_id>
            </event>
            <event type=“dtmf”>
                <action type=“dtmf_detection”
action_id=“main_menu_selection” timeout=“10sec” digit_timeout=“4sec”>
                    <case case_id=“first_choice>1</case>
                    <case case_id=“second_choice>2</case>
                </action>
            </event>
            <event type=“speech”>
                <action type=“speech_recognition”
action_id=“main_menu_selection” timeout=“10sec”>
                    <grammar grammar_id=“cae2ac38-f5f1-41ca-
b452-dd3237f6eec6”>
                        <case case_id=“first_choice>
                            <!-- in-line grammar definition for
this case -->
                            <phrase>english</phrase>
                        </case>
                        <case case_id=“second_choice”>
                            <!-- pre-loaded grammar definition
for this case -->
                            <grammar resource_id=“1dc956e5-
d637-49d0-b9a9-9b0a3e9d1e9f”/>
                        </case>
                        <default case_id=“unknown”/>
                    </grammar>
                </action>
            </event>
            <event type=“no_response”>
                <case_id>no_response</case_id>
            </event>
        </action>
        <if action=“main_menu” case_id=“hang_up”>
            <action type=“terminate_call” call_id=“1037c966-be6d-4fcf-
950f-13e3139d2426”/>
            <return value=“status”>hanged up</return>
            <else>
                <if action=“main_menu” case_id=“no_response”>
                    <action type=“terminate_call” call_{—}
id=“1037c966-be6d-4fcf-950f-13e3139d2426”/>
                    <return value=“status”>no response</return>
                    <else>
                        <switch action=“main_menu”>
                            <case case_id=“first_choice”>
                                <return value=“status”>
                                    <!-- execute pre-
loaded program fragment -->
                                    <action
type=“execute” prog_id=“59dc1594-7e2f-479c-9bfd-779adfd44542”>
                                        <arguments>
<argument name=“call_id”>1037c966-be6d-4fcf-950f-13e3139d2426</argument>
<argument name=“office_number”>7819879876</argument>
<argument name=“mobile_number”>7815543532</argument>
</arguments>
                                    </action>
                                </return>
                            </case>
                            <case case_id=“second_choice”>
                                <return value=“status”>
                                    <!-- execute pre-
loaded program fragment -->
                                    <action
type=“execute” prog_id=“b5ed8b12-ffc0-4653-94d2-74e596f62069”>
                                        <arguments>
<argument name=“call_id”>1037c966-be6d-4fcf-950f-13e3139d2426</argument>
<argument name=“e_mail”>support@macrohard.com</argument>
<argument name=“address”>44 school street, boston, MA</argument>
</arguments>
                                    </action>
                                </return>
                            </case>
                            <case case_id=“unknown”>
                                <return
value=“status”>selection unknown</return>
                            </case>
                        </switch>
                    </else>
                </if>
            </else>
        </if>
    </if>
    <return value=“call_status”>
        <!-- return status of the call -->
        <action type=“get_status”>
            <item type=“call”>1037c966-be6d-4fcf-950f-
13e3139d2426</item>
        </action>
    </return>
</program>
```

While this invention has been particularly shown and described with references to preferred embodiments thereof, it will be understood by those skilled in the art that various changes in form and details may be made therein without departing from the scope of the invention encompassed by the appended claims.

What is claimed is:

1. A method of providing a voice service to a telephony device over a telephony network comprising:
sending a voice service control instruction from a client network device to a server network device over a non-local network; and
executing the voice service control instruction using the server network device to control a voice service provided to the telephony device over the telephony network.

2. The method of claim 1 wherein the non-local network is the Internet.

3. The method of claim 1 wherein the voice service control instruction is sent under Hypertext Transfer Protocol.

4. The method of claim 1 wherein the voice service control instruction is Extensible Markup Language compliant.

5. The method of claim 1 wherein the telephony network comprises wireless telephony devices.

6. The method of claim 1 wherein the telephony network is the Public Switched Telephone Network.

7. The method of claim 1 wherein controlling the voice service comprises sending a telephony control instruction from the server network device to a telephony control device on the telephony network.

8. The method of claim 1 wherein the voice service comprises text-to-speech conversion.

9. The method of claim 1 wherein the voice service comprises automatic speech recognition.

10. The method of claim 1 wherein the voice service comprises speaker recognition.

11. A method of controlling connection of a telephony device to a telephony control device on a telephony network comprising:
sending a call status request from a client network device to a server network device over a non-local network;
sending a call status response from the server network device to the client network device over the non-local network;
sending a connection control instruction from the client network device to the server network device over the non-local network; and
executing the connection control instruction using the server network device to control connection of the telephony device to the telephony device over the telephony network.

12. The method of claim 11 wherein the non-local network is the Internet.

13. The method of claim 11 wherein the connection control instruction is sent under Hypertext Transfer Protocol.

14. The method of claim 11 wherein the connection control instruction is Extensible Markup Language compliant.

15. The method of claim 11 wherein the telephony network comprises wireless telephony devices.

16. The method of claim 11 wherein the telephony network is the Public Switched Telephone Network.

17. The method of claim 11 wherein controlling comprises sending a telephony control instruction from the server network device to the telephony control device on the telephone network.

18. The method of claim 11 wherein the connection control instruction is sent only if the call status response satisfies a criterion.

19. A method of controlling connection of a telephony device to a telephony control device on a telephony network comprising:
sending a call status message from a server network device to a client network device over a non-local network, the server network device being coupled to the telephony control device;
sending a connection control instruction from the client network device to the server network device over the non-local network; and
executing the connection control instruction using the server network device to control connection of the telephony device to the telephony device over the telephony network.

20. The method of claim 19 wherein the non-local network is the Internet.

21. The method of claim 19 wherein the connection control instruction is sent under Hypertext Transfer Protocol.

22. The method of claim 19 wherein the connection control instruction is Extensible Markup Language compliant.

23. The method of claim 19 wherein the telephony network comprises wireless telephony devices.

24. The method of claim 19 wherein the telephony network is the Public Switched Telephone Network.

25. The method of claim 19 wherein controlling comprises sending a telephony control instruction from the server network device to the telephony control device on the telephony network.

26. The method of claim 19 wherein the connection control instruction is sent only if the call status response satisfies a criterion.

27. A method of providing a telephony service to a telephony device over a telephony network comprising:
sending a telephony script from a client network device to a server network device over a non-local network; and
executing the telephony script using the server network device to control the telephony services provided to the telephony device over the telephony network.

28. The method of claim 27 wherein the non-local network is the Internet.

29. The method of claim 27 wherein the telephony script is sent under Hypertext Transfer Protocol.

30. The method of claim 27 wherein the telephony script is Extensible Markup Language compliant.

31. The method of claim 27 wherein the telephony network comprises wireless telephony devices.

32. The method of claim 27 wherein the telephony network is the Public Switched Telephone Network.

33. The method of claim 27 wherein executing the telephony script comprises sending a telephony control instruction from the server network device to the telephony control device on the telephony network.

34. The method of claim 27 wherein the telephony script includes branching logic instructions.

35. The method of claim 27 wherein the telephony script is generated by the client in response to the client's status.

36. The method of claim 27 wherein the telephony script is generated by the client in response to the server's status.

37. The method of claim 27 wherein the telephony script is generated by the client in response to a client's human user's input.

38. A method of providing a service to a telephony device over a telephony network comprising:
sending control information from a client network device to a server network device over a non-local network; and
processing the control information using the server network device to control a service provided to the telephony device over the telephony network.

39. The method of claim 38 wherein the control information comprises a voice service control instruction.

40. The method of claim 38 wherein the control information comprises a telephony script.

41. A system for providing a service to a telephony device over a telephony network comprising:
a server network device; and
a client network device for sending control information to the server network device over a non-local network, the server network device processing the control information to control a service provided to the telephony device over the telephony network.
